(19) United States
(12) Patent Application Publication
(10) Pub. No.: US 2009/0211242 A1
(43) Pub. Date: Aug. 27, 2009

(54) Engines Driven by Liquefied Gas

(75) Inventor: Peter Thomas Dearman, Hertfordshire (GB)

Correspondence Address: BARNES & THORNBURG LLP, P.O. BOX 2786, CHICAGO, IL, 60690-2786, US

(73) Assignee: Twisley, Catsfield, Battle (GB)

(21) Appl. No.: 11/912,483

(22) PCT Filed: Apr. 28, 2006
(86) PCT No.: PCT/GB06/01581

§ 371 Date: Jul. 30, 2008

(30) Foreign Application Priority Data
May 3, 2005 (GB) 0508902.4

(51) Int. Cl. F01K 25/06; F01B 17/02; F02G 1/04

(52) U.S. Cl. 60/516

(57) ABSTRACT

In an engine driven by liquefied gas, such as liquefied nitrogen or air, inlet means (31, 33) admits drive fluid to an expansion chamber defined by the volume between two relatively movable members (1, 28) guided for movement in a repetitive cycle by guide means (38, 40). The inlet means also allows a heat exchange liquid to be admitted to the chamber in which the liquid is in intimate contact with the drive fluid and gives up heat energy to the expanding drive fluid. The cooled heat-exchange liquid is withdrawn from the chamber, heated and re-circulated to the chamber. Part of said cycle includes a time period during which there is substantially no relative movement between the members (1, 28) and during which the chamber volume is maintained at or close to its minimum volume, the heat-exchange liquid and drive fluid being admitted to the chamber during said time period. This promotes intimate contact and heat-exchange between the drive fluid and the heat-exchange liquid prior to the drive stroke which delivers the shaft power developed by the engine.

This invention relates to engines driven by liquefied gas.

In a known engine of this type, liquid nitrogen is admitted to an expansion chamber. The nitrogen expands and drives a piston or rotor within the chamber to produce shaft power. The expansion of the nitrogen causes cooling and the cooling effect itself limits the potential for gas expansion. As a result, the efficiency of known engines of this type is low, and this problem is tackled in the inventor's Patent Specification WO 01/63099. The present invention aims further to improve the efficiency of engines driven by liquefied gas.

According to one aspect of the invention an engine comprises an expansion chamber defined by the volume between two relatively movable members guided for movement in a repetitive cycle by guide means, inlet means for admitting to the chamber a drive fluid in a refrigerated condition, and also for admitting to the chamber a heat-exchange liquid, outlet means for withdrawing the heat-exchange liquid, in a cooled state, from the chamber and a heat-exchanger for increasing the temperature of the withdrawn heat-exchange liquid prior to re-circulation of the heat-exchange liquid through the chamber, wherein part of the cycle includes a time period during which there is substantially no relative movement between the members and during which the chamber volume is maintained at or close to its minimum volume, in use the heat exchange liquid and the drive fluid being admitted to the chamber during said time period and the drive fluid then expanding to increase the volume of the chamber and the heat-exchange liquid giving up heat energy to the expanding drive fluid, the expansion of the drive fluid causing the generation of shaft power by the engine.

According to another aspect of the invention there is provided a method of generating shaft power from a drive fluid in a refrigerated condition, comprising admitting the drive fluid to an expansion chamber defined by the volume between two relatively movable members guided for movement in a repetitive cycle by guide means, allowing the drive fluid to expand in the chamber to produce shaft power, wherein a heat-exchange liquid is additionally admitted to the chamber where the heat-exchange liquid gives up heat energy to the expanding drive fluid, the cooled heat-exchange liquid being withdrawn from the chamber, heated and re-circulated to the chamber, wherein part of the cycle includes a time period during which there is substantially no relative movement between the members and during which the chamber volume is maintained at or close to its minimum volume, and wherein the heat exchange liquid and the drive fluid are admitted to the chamber during said time period.

The introduction of the drive fluid and the heat-exchange liquid into the chamber whilst the latter is maintained at or close to its minimum volume for a finite time period promotes intimate contact and heat exchange between the drive fluid and the heat-exchange liquid prior to the drive stroke which delivers the shaft power.

Preferably, the relatively movable members comprise a cylinder and a piston reciprocatable within the cylinder, the piston being maintained at or close to its top dead centre position during said time period.

The guide means may include a cam and a cam follower, and in this case the cam profile preferably includes a part-circular portion which is centred on the rotational axis of the cam and over which the cam follower rides during said time period which may be between one third and one half of the time for one cycle. In the preferred embodiment the cycle is a two-stroke cycle.

According to a further aspect of the invention an engine comprises an expansion chamber, inlet means for admitting to the chamber a drive fluid in a refrigerated condition, and also for admitting to the chamber a heat-exchange liquid, outlet means for withdrawing the heat-exchange liquid, in a cooled state, from the chamber and a heat-exchanger for increasing the temperature of the withdrawn heat-exchange liquid prior to re-circulation of the heat-exchange liquid through the chamber, in use the drive fluid expanding in the chamber and the heat-exchange liquid giving up heat energy to the expanding drive fluid, the expansion of the drive fluid causing the generation of shaft power by the engine, wherein the inlet means include a pump for pumping the heat-exchange liquid into the chamber.

By using a pump, the heat-exchange liquid can be injected into the chamber at a pressure and volume to optimise engine performance. In particular, the use of a pump speeds the injection process and ensures that the chamber is filled.

The heat-exchange liquid is preferably at or close to ambient temperature when it is supplied to the chamber.

The drive fluid is preferably liquified nitrogen or air or, less preferably, liquified carbon dioxide, or any mixture of these or other gases.

A preferred embodiment of the invention will now be described, by way of example, with reference to the accompanying drawings, in which:

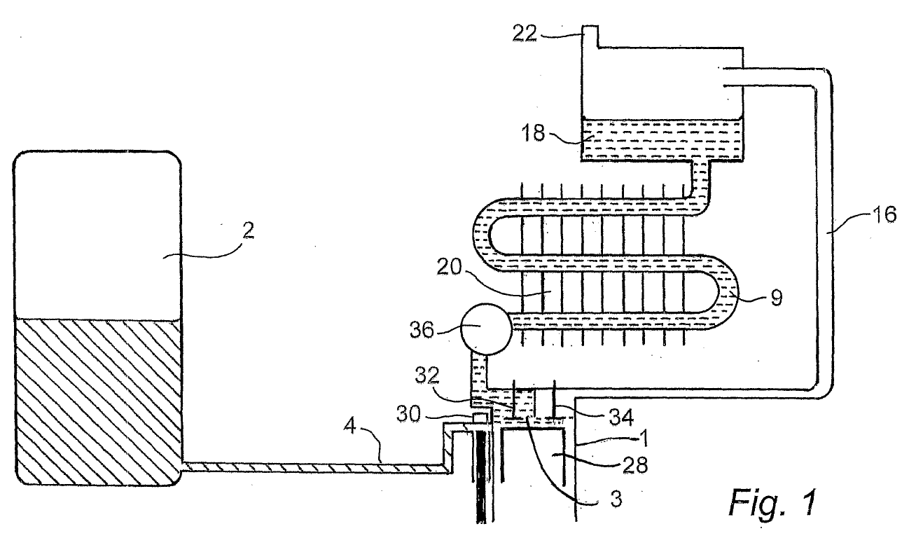

FIG. 1 is a diagrammatic view of a rotary engine according to the invention,

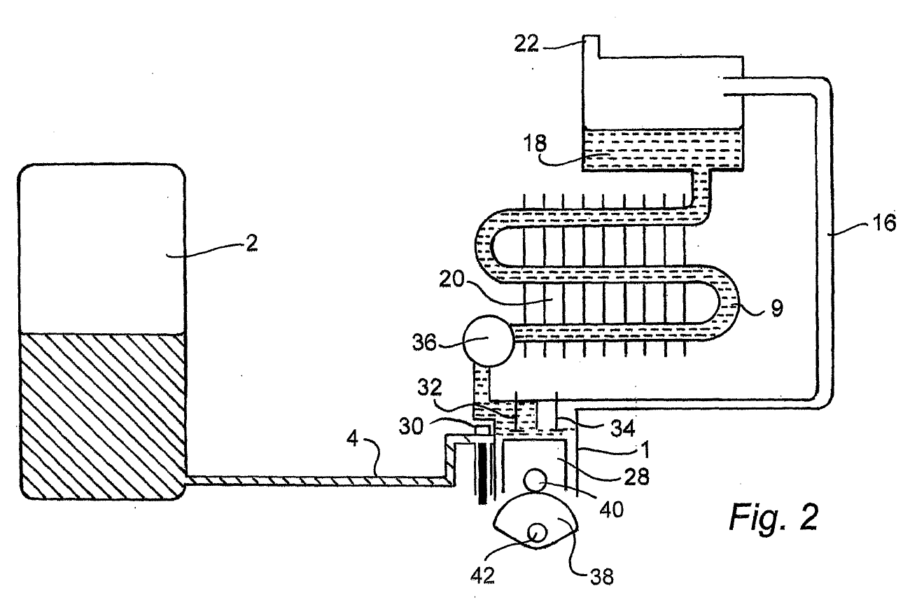

FIGS. 2 to 4 show the engine at different times in its cycle of operation, and

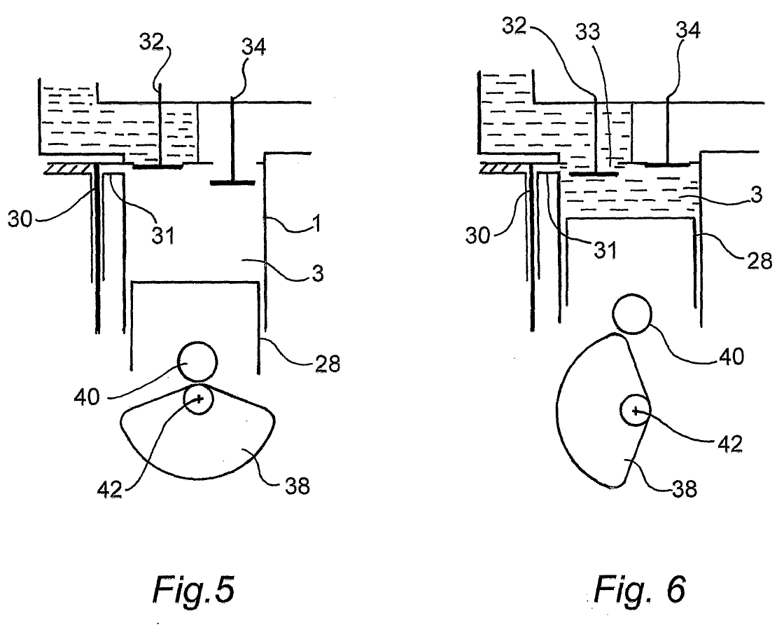

FIGS. 5 to 8 show movable parts of the engine, to an enlarged scale, at different time in its cycle of operation.

Throughout the drawings, corresponding parts bear the same reference numerals.

Referring to FIG. 1, the engine has a cylinder 1 within which is a reciprocatable piston 28. The chamber 3 defined between the piston and cylinder varies in volume as the piston undergoes its repetitive two-stroke cycle.

A pressurised storage tank 2 holds a supply of drive fluid in the form of liquid nitrogen at about −200° C. Liquid nitrogen is fed to the chamber 3 through a supply pipe 4 and a flow control device 30, for example, a rotary valve. First inlet means 31 admit the liquid nitrogen to the chamber 3. A heat-exchange liquid, such as ethylene glycol, is also supplied to the chamber 3 through a second inlet means 33 fed by a supply pipe 9 drawing heat-exchange liquid from a reservoir 18. The supply pipe 9 includes a pump 36 for delivering the heat-exchange liquid to the chamber 3 at the desired pressure. Heat-exchange liquid is withdrawn from the chamber 3 through a return pipe 16 which returns the heat-exchange liquid to the reservoir 18. In its passage from the reservoir 18 to the chamber 3, the heat-exchange liquid passes through a heat-exchanger 20 provided with a plurality of fins.

The top of the cylinder 1 has an inlet valve 32 for admitting the liquefied nitrogen and the heat-exchange liquid to the chamber 3, and also an outlet valve 34 for the passage of the expanded nitrogen and the cooled heat-exchange liquid from the chamber 3 to the return pipe 16. The nitrogen is exhausted or bled off from the reservoir by an outlet 22.

Referring to FIGS. 2 to 8, the reciprocating movement of the piston 28 within the cylinder 1 is governed by a rotatable cam 38 having a lobe-shaped outer periphery engaged by a cam follower 40 attached to the piston 28. The cam 38 rotates clockwise as viewed in FIGS. 2 to 8, about the rotational axis indicated at 42. The outer periphery of the cam 38 has a part-circular portion centred on the axis 42 and subtending an angle of 170° to 180° at the axis 42, two substantially rectilinear flanks and a short curved transition linking the flanks.

As the cam 38 rotates, the piston 28 undergoes repetitive cycles of movement and it can be seen that for almost half of the periodic time (that is the time for one cycle), the cam follower 40 rides over the part-circular portion of the cam 38 and the piston 28 is maintained at its top dead centre position where the chamber 3 has a minimum volume, as illustrated in FIG. 2. During this time period, the valve 32 is open to admit first the heat-exchange liquid (under pressure from the pump 36) and then the liquid nitrogen. For a cylinder of 500 cc capacity, 25 cc of heat-exchange liquid plus 1 cc of nitrogen may be injected into the chamber 3 at the commencement of each power stroke. During injection, the valve 34 remains closed.

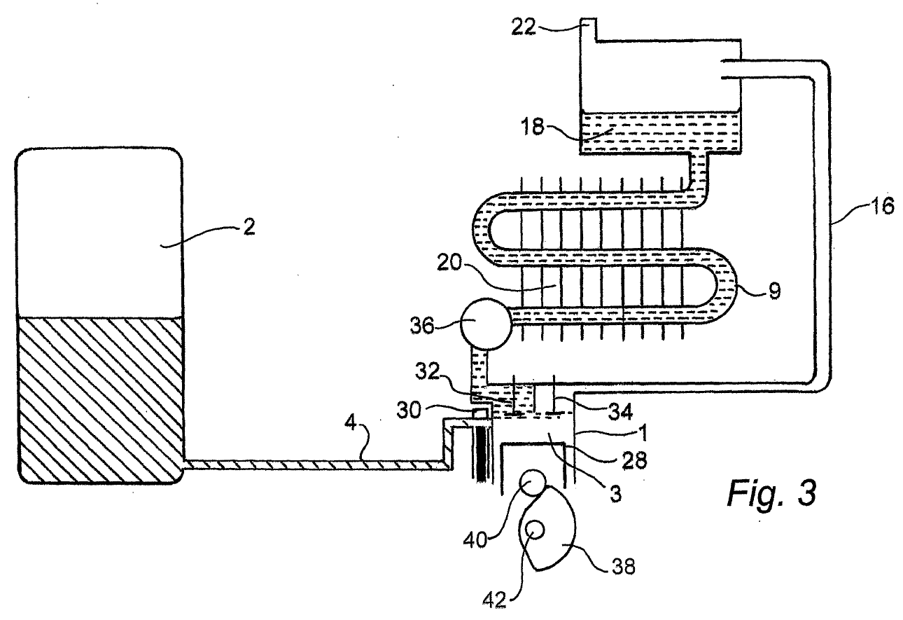

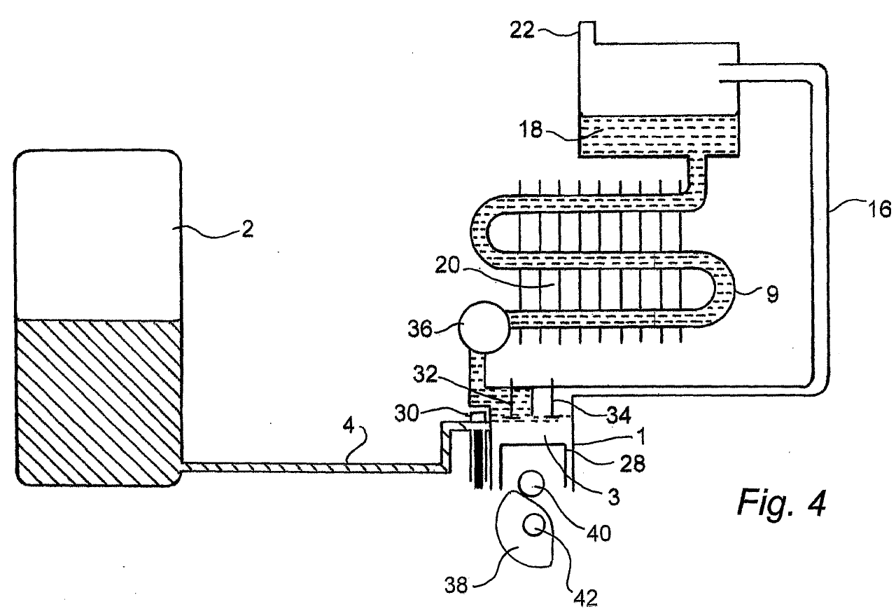

At the end of this time period, the valve 32 closes, the cam follower 40 moves onto one of the flanks (FIG. 3) and the expanding nitrogen causes the piston 28 to undergo a power stroke. The expansion of the nitrogen causes cooling but the expanding nitrogen absorbs heat energy from the heat-exchange liquid which is therefore cooled. When the cam follower 40 rides over the short curved transition of the cam profile, the piston 28 is at bottom dead centre. On the return stroke of the piston 28 (FIG. 4), the cam follower 40 engages the other flank, the piston 28 returns towards the top of the cylinder and the valve 34 opens to release the spent fluids through the pipe 16. The valve 34 closes before the onset of the succeeding power stroke of the piston 28.

The heat-exchange liquid is pumped into the chamber by the pump 36. When inside the chamber 3, the heat-exchange liquid is in intimate contact with the nitrogen, so effective heat transfer takes place from the heat-exchange liquid to the expanding nitrogen. This transfer of heat energy to the nitrogen increases the amount by which the nitrogen expands, so increasing the amount of shaft power produced by the engine. The heat-exchange liquid is recirculated through the chamber 18, passing through the heat-exchanger 20 in order to return its temperature to ambient.

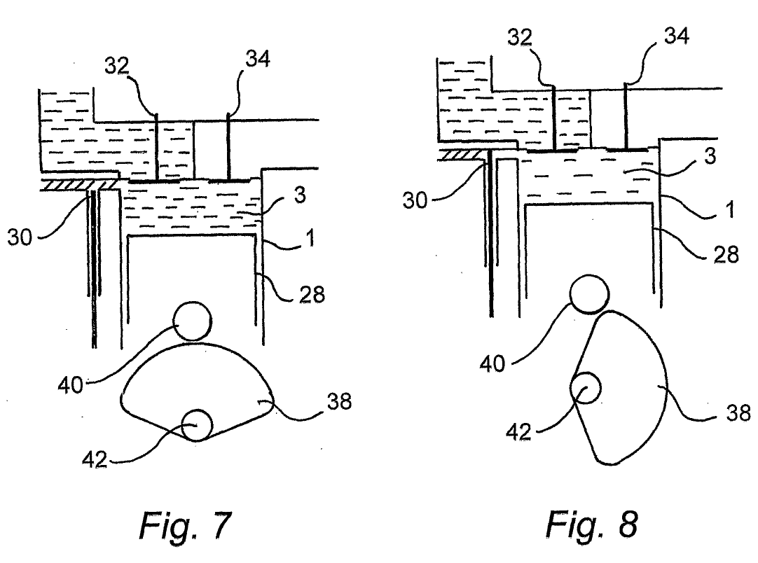

In the sequence of views of FIG. 5 to 8, FIG. 5 shows the start of the cycle with the valve 30 closed, the inlet valve 32 closed and the outlet valve 34 open. FIG. 6 shows the inlet valve 32 open, for the entry of heat exchange liquid into the cylinder 3, with the valve 30 and the outlet valve 34 both closed. FIG. 7 shows the valves 32 and 34 both closed and the valve 30 open, allowing liquid nitrogen into the chamber. FIG. 8 shows the start of the power stroke with the valves 30, 32 and 34 all closed, the liquid nitrogen and the heat exchange liquid mixing in the chamber 3.

1. An engine comprising an expansion chamber defined by the volume between two relatively movable members guided for movement in a repetitive cycle by guide means, inlet means for admitting to the chamber a drive fluid in a refrigerated condition, and also for admitting to the chamber a heat-exchange liquid, outlet means for withdrawing the heat-exchange liquid, in a cooled state, from the chamber wherein part of the cycle includes a time period during which there is substantially no relative movement between the members and during which the chamber volume is maintained at or close to its minimum volume, in use the heat exchange liquid and the drive fluid being admitted to the chamber during said time period and the drive fluid then expanding to increase the volume of the chamber and the heat-exchange liquid giving up heat energy to the expanding drive fluid, the expansion of the drive fluid causing the generation of shaft power by the engine.

2. An engine according to claim 1, in which the relatively movable members comprise a cylinder and a piston reciprocatable within the cylinder, the piston being maintained at or close to its top dead centre position during said time period.

3. An engine according to claim 1, in which the guide means includes a cam and a cam follower.

4. An engine according to claim 3, in which the cam profile includes a part-circular portion which is centred on the rotational axis of the cam and over which the cam follower rides during said time period.

5. An engine according to claim 1 in which said period is between one third and one half of the time for one cycle.

6. An engine according to claim 1, in which the engine operates on a two stroke cycle.

7. An engine according to claim 1, wherein the inlet means include a pump for pumping the heat exchange liquid into the chamber.

8. An engine comprising an expansion chamber, inlet means for admitting to the chamber a drive fluid in a refrigerated condition, and also for admitting to the chamber a heat-exchange liquid, outlet means for withdrawing the heat-exchange liquid, in a cooled state, from the chamber and a heat-exchanger for increasing the temperature of the withdrawn heat-exchange liquid prior to re-circulation of the heat-exchange liquid through the chamber, in use the drive fluid expanding in the chamber and the heat-exchange liquid giving up heat energy to the expanding drive fluid, the expansion of the drive fluid causing the generation of shaft power by the engine, wherein the inlet means include a pump for pumping the heat-exchange liquid into the chamber.

9. An engine according to claim 8, in which the heat-exchange liquid is at or close to ambient temperature when it is supplied to the chamber.

10. An engine according to claim 8, in which the drive fluid is liquefied nitrogen or air or, any mixture of these or other gases.

11. A method of generating shaft power from a drive fluid in a refrigerated condition, the method comprising admitting the drive fluid to an expansion chamber defined by the volume between two relatively movable members guided for movement in a repetitive cycle by guide means, allowing the drive fluid to expand in the chamber to produce shaft power, wherein a heat-exchange liquid is additionally admitted to the chamber where the heat-exchange liquid gives up heat energy to the expanding drive fluid, the cooled heat-exchange liquid being withdrawn from the chamber, heated and re-circulated to the chamber, wherein part of the cycle includes a time period during which there is substantially no relative movement between the members and during which the chamber volume is maintained at or close to its minimum volume, and wherein the heat exchange- liquid and the drive fluid are admitted to the chamber during said time period.

12. A method according to claim 11, in which the relatively movable members comprise a cylinder and a piston reciprocatable within the cylinder, the piston being maintained at or close to its top dead centre position during said time period.

13. A method according to claim 11, in which the guide means include a cam and a cam follower.

14. A method according to claim 13, in which the cam profile includes a part-circular portion which is centred on the rotational axis of the cam and over which the cam follower rides during said time period which may be between one third and one half of the time for one cycle.

15. A method according to claim 11, in which the cycle is a two stroke cycle.

16. A method according to claim 11, in which the heat-exchange liquid is at or close to ambient temperature when it is supplied to the chamber.

17. A method according to claim 11, in which the drive fluid is liquefied nitrogen or air or any mixture of these.

18. An engine according to claim 1, wherein the engine further comprises a heat-exchanger for increasing the temperature of the withdrawn heat-exchange liquid prior to recirculation of the heat-exchange liquid through the chamber.

19. An engine according to claim 1 in which the heat-exchange liquid is at or close to ambient temperature when it is supplied to the chamber.

20. An engine according to claim 1, in which the drive fluid is liquefied nitrogen or air or, any mixture of these or other gases.
